(19) United States
(12) Patent Application Publication
(10) Pub. No.: US 2010/0097215 A1
(43) Pub. Date: Apr. 22, 2010

(54) SECURITY MATERIAL HAVING A WEB-LIKE INTERLACED FABRIC

(75) Inventor: Ivo Locher, Zug (CH)

Correspondence Address: Studebaker & Brackett PC, One Fountain Square, 11911 Freedom Drive, Suite 750, Reston, VA, 20190, US

(73) Assignee: SEFAR AG, Heiden (CH)

(21) Appl. No.: 12/566,256

(22) Filed: Sep. 24, 2009

(30) Foreign Application Priority Data
Oct. 22, 2008 (EP) 08018505.1

(51) Int. Cl. G08B 13/00

(52) U.S. Cl. 340/550

(57) ABSTRACT

The invention relates to a security material having a web-like interlaced fabric and insulated, electrically conductive wires integrated therein. Provision is made for a first wire to be arranged in the longitudinal direction of the web-like interlaced fabric and for a second wire to extend in a meandering manner across the width of the web-like interlaced fabric in the longitudinal direction thereof.

The invention relates to a security material having a web-like interlaced fabric and insulated, electrically conductive wires integrated therein.

Materials of such type are known and employed for detecting breaking and entering in particular into truck or shipping containers. Other possibilities of application reside, for example, in the protection of valuable commodities, property, fences, warehouses, museums etc. For these purposes the security material can be produced so thin that an intruder does not usually become aware of the presence of the security material or considers it to be a packaging or covering material. In such a case a loud or silent alarm can be triggered in a monitoring station or the intrusion can be recorded in a database.

If the security material is severed in any place, the wafer-thin wires integrated therein are also damaged and this is detected by a connected evaluation electronics and interpreted as an attempted intrusion.

Security materials of such kind are known for instance from EP 0 725 881 B1 or U.S. Pat. No. 7,352,284 B2.

The object of the invention is to provide a security material with a web-like interlaced fabric and wires integrated therein, which can be produced in a cost-saving and simple way whilst still being capable of reliably detecting damage to the security material.

This object is solved by a security material having the features of claim 1. Preferred embodiments are stated in the dependent claims.

The security material according to the invention is characterized in that a first wire is arranged in the longitudinal direction of the web-like interlaced fabric and in that a second wire extends in a meandering manner across the width of the web-like interlaced fabric in the longitudinal direction thereof.

A fundamental idea of the invention can be regarded in the way how the security material is interspersed with wires. Here, one wire runs in a loop-shaped manner through the web-like interlaced fabric along its width so that the area run through by the wire covers the interlaced fabric over its total surface. A further wire is connected at one end of the web-like interlaced fabric to the other wire and is guided back from there along the length. By measuring the conductivity on the two remaining free ends of the wires a breaking and entering, whereby a wire is severed, can thus be detected in a simple way. Such a wire arrangement can be produced in an effective and economical manner in a interlaced fabric. The interlaced or knitted fabric comprises a band-like or belt-like arrangement with interlaced yarns.

In accordance with the invention it is especially preferred that the first wire is arranged on a periphery of the interlaced fabric. In this way the advantageous achievement is that electrical connections, whether it concerns connections to a measurement electronics or connections to the second wire, can be guided through on the periphery of the fabric. This has the advantage that connecting cables do not have to be guided in long complicated ways from the center of the side of the interlaced fabric towards the connecting points but instead they can be connected in a direct and space-saving manner.

Another advantageous embodiment of the invention is characterized in that on at least one side surface of the interlaced fabric the wires do not protrude from the side surface for protection against damage. As a result of this arrangement of the wires, whether located in the center of the interlaced fabric or on a front or rear side of the interlaced fabric, the advantageous achievement is that the sensitive wires are protected against an accidental damage, as for example during the installation of the security material.

Furthermore, in accordance with the invention it is preferred that the spacing of two adjacent sections of the second wire to each other lies in the range of millimeters, in particular 2.3 mm. The spacing can range between 1 mm and 20 mm. As a result, it is achieved that the wire network, which extends in the longitudinal direction and across the width of the web-like interlaced fabric, in particular in sections or, however, across the entire width of the interlaced fabric, constitutes a very fine-meshed network with a maximum spacing lying in the range of millimeters. Consequently, it is almost impossible for an intruder to sever the security material without any damage also being done to the meandering second wire at the same time.

In conjunction with this a further especially advantageous embodiment of the invention is characterized in that the wires are enamel-insulated metal wires, in particular copper wires, the diameters of which lie in the range of some 50 micrometers, in particular between 100 and 150 μm. Through the enamel insulation of the metal wires the advantageous achievement is that in the case of contact of electrically conductive objects, such as e.g. metals or the like, no electrical connection can be established between different wire sections, which might affect a connected measurement electronics that measure the conductivity or other electrical properties of the metal wires. Copper is excellently suitable for this as copper features an extremely good conductivity. On account of the small diameter of the wires the advantageous achievement is that even attempted intrusions with a minimum of force input lead to the damage or severing of such a wire, whereupon the attempted intrusion is detected.

In addition, according to the invention provision is made for each wire to have a respective connecting element for electrically connecting the wires to a measurement electronics. In this way the advantageous achievement is that through connection of the connecting elements to the corresponding connecting elements of a measurement electronics or the like the wires can be connected in a simple way to an analyzing device. This is intended in particular for the analysis of the resistance or of the chronological variation of the conductivity, respectively, especially of the two series-connected wires. In this way it can be established whether the two wires are intact or have already been severed. A monitoring with chronological variation also allows for the detection of a possible bridging. By way of pulsed measurement methods it is also possible to detect at which place along the length of the web-like interlaced fabric a wire interruption has been taken place, if use is made of line pairs such as twin strands or coaxial cables. In general, the place can be detected if constant characteristic impedance is prevailing along the line. An interlaced fabric is to be considered in particular as a structure consisting partly of a woven fabric and partly of a knitted fabric.

Furthermore, here it is especially preferred that the first wire and the second wire are electrically connected to each other at their adjacent ends and the two other ends of the wires are connected to the measurement electronics for measuring the conductivity of the connected wires. As a result of this measure and in consideration of the fact that the two wires cover the entire surface of the web-like interlaced fabric in a tight-meshed way, it is possible to monitor the complete surface of the security material. In this way any damage that occurs at any chosen place and that is greater than a mesh can be detected. Thus, a security monitoring of any chosen surface that can be covered by a web-like material is rendered possible at a high security standard.

Another advantageous embodiment of the invention resides in the fact that the electrical connection of the wires to the measurement electronics is effected through soldering, welding or by means of insulation displacement connectors. By way of these connecting techniques an easy-to-realize, inexpensive and reliable electrical connection between the wires is achieved in an advantageous manner.

Furthermore, provision is made according to the invention for the electrical connection of the wires to the measurement electronics to be effected by way of a printed circuit board fixed on the interlaced fabric. In this case it is especially preferred that the connection between one of the wires and a point of connection on the printed circuit board is located directly underneath the surface of the printed circuit board. However, depending on the geometry of the first and second wire it is also possible for the point of connection between the first or the second wire and the point of connection on the printed circuit board to be connected via an additional wire. From the point of connection located on the printed circuit board a conductor path leads to a further connection that is connected to the measurement electronics e.g. by way of a cable. Here, for mechanical tension relief it is particularly advantageous that the printed circuit board is also fixed, especially interlocked mechanically or bonded onto the interlaced fabric. Depending on the purpose of application, here, provision can be made for the printed circuit board to be designed in a flexible or rigid manner.

Another advantageous embodiment of the invention resides in the fact that the meanders of the second wire protrude laterally in the form of loops from the web-like interlaced fabric. This form of wire loops is very easy to produce in practice.

In conjunction with this provision is furthermore made according to the invention in that for protection of the wire loops the lateral interlaced fabric edges and the wire loops are embedded in a seam tape, in particular having a thickness of 250 μm. Since the loop shape of the wires that protrudes laterally from the interlaced fabric can easily be damaged, a protection of the wires is necessary. To this end a seam tape, in particular a so-called hot-melt seam tape is employed. The elongated tape is placed lengthwise around an edge of the interlaced fabric and therefore also along the wire loops, it is then folded over towards the two side surfaces of the interlaced fabric and pressed tightly with its adhesive side onto the respective side surfaces of the interlaced fabric. By preference, the tape is pressed without folding-over into the fabric by making use of heat. What is also conceivable is the use of a simple adhesive tape.

Another advantageous embodiment of the security material according to the invention is characterized in that the interlaced fabric has an opening for passing through lines, feed-throughs, connecting and fixing elements or the like, without interrupting wire connections at the place of the opening. In accordance with the invention two possibilities are provided here. The first possibility resides in a printed circuit board being fixed on the interlaced fabric above the opening and said printed circuit board is larger than the opening and its conductor paths connect the respective ends of each wire connection to each other. The printed circuit board also has to have an opening that is at least of such a dimension that the used feed-through fits through. As a result, the advantageous achievement is that feed-throughs, such as e.g. lines, connections and fixing elements, can be guided through the security material without causing damage to the tight-meshed wire network thereby. Another possibility of introducing an opening into the security material is to make a small slot along the width of the interlaced fabric along the wire sections of the second wire into the interlaced fabric. If the two slot ends in the interlaced fabric are moved towards each other a slot-shaped opening appears in the interlaced fabric, through which feed-throughs can be introduced. In addition, the interlaced fabric in the vicinity of the slot can be reinforced by a seam tape that is also cut open at the slot opening.

Finally, according to the invention it is preferred that the interlaced fabric has at regular intervals in the longitudinal direction, in particular every 25 mm, a marker line in the form of a missing thread that extends along the width. Since the material is present in web-like form, it is easily possible to measure and cut off specific lengths of the material. Due to the fact that the marker line extends in the material in the form of a missing thread the material can be cut easily at this place, too.

In the following the invention will be described further by way of preferred embodiments illustrated in the accompanying Figures, wherein:

FIG. 1 shows a schematic top view of an embodiment of a security material in accordance with the invention;

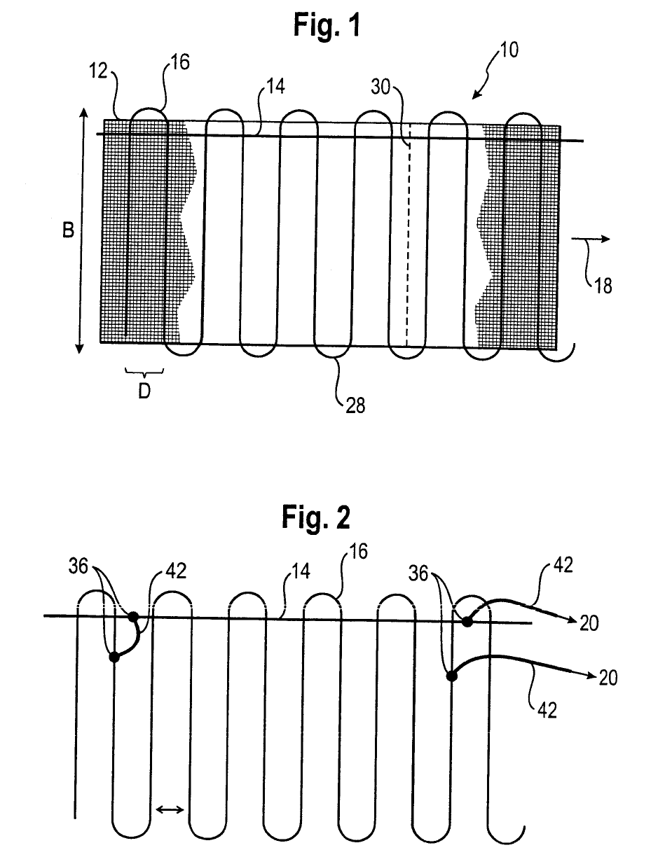

FIG. 2 shows the electrical contacting of the security material from FIG. 1;

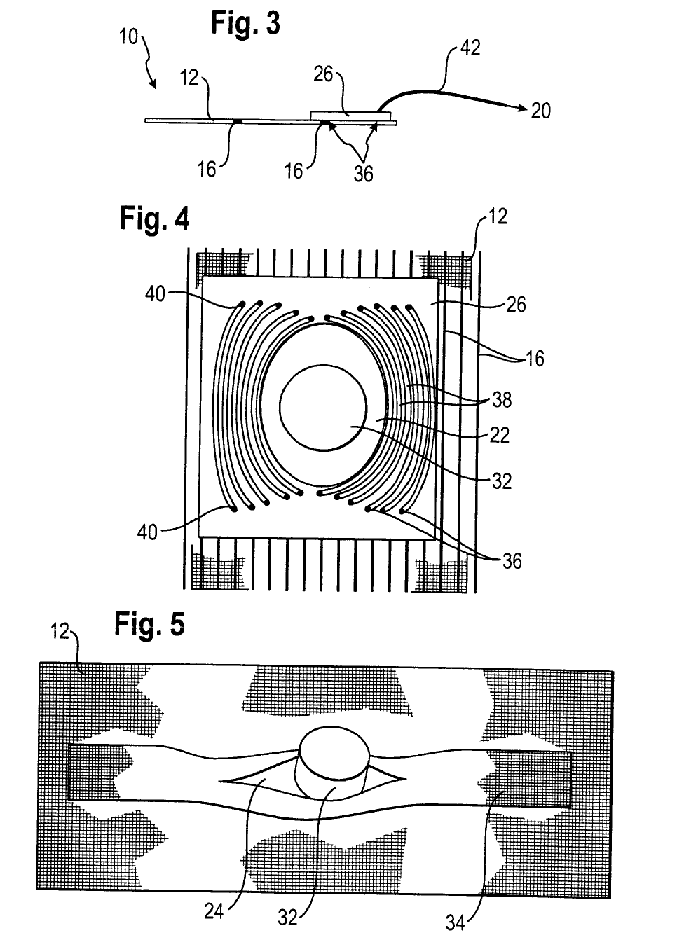

FIG. 3 shows in a schematic side view the electrical contacting of the wires for an embodiment of the invention;

FIGS. 4 and 5 show further embodiments with openings in the interlaced fabric for passing through lines.

FIG. 1 shows a security material 10 according to the invention that consists of a web-like interlaced fabric 12 and insulated, electrically conductive wires 14, 16 integrated therein. A first wire 14 is arranged on the periphery of the interlaced fabric 12 in the longitudinal direction 18 of the web-like interlaced fabric 12. A second wire 16 extends in a meandering manner across the entire width B of the web-like interlaced fabric 12 along the longitudinal direction 18 of the interlaced fabric 12 and thereby crosses the first wire 14 repeatedly. The adjacent parallel sections of the second wire 16 each have a spacing D to one another. In the bends of the meandering course of the second wire 16, wire loops 28 are formed that protrude in the direction of the width B of the web-like interlaced fabric 12 from the edges of the interlaced fabric 12. In the interlaced fabric 12 marker lines 30 are also located at regular intervals in the longitudinal direction in the form of a missing thread that extends across the entire width of the interlaced fabric 12. The interlaced fabric 12 itself can be composed of monofilament or multifilament threads, more particularly of a plastic material. In the longitudinal direction 18 the threads can be arranged like the first wire 14 as weft threads, while the threads extending in the width direction and the second wire 16 can be considered as warp threads.

FIG. 2 illustrates the electrical connections 36 of a security material 10 according to the invention from FIG. 1. After the web-like security material 10 has been cut to length, on the left and right end of the interlaced fabric 12 a course of the first wire 14 and the second wire 16 can develop as depicted in FIG. 2. In the present embodiment the first wire 14 and the second wire 16 are connected to each other in an electrically conductive manner at the left end by means of two electrical connections 36. At the right end the two wires 14, 16 are each connected via a cable to a measurement electronics 20. As a result of this arrangement the two wires 14, 16 are, as it were, connected in series and both ends of this series connection are connected to the measurement electronics 20. The measurement electronics 20 measure the electrical conductivity of the series connection of the first wire 14 and the second wire 16 as well as of the interconnected cables 42. Due to the arrangement of the electrical connections 36 in FIG. 2 it is not possible to measure the sections of the wires 14, 16 located to the left of the electrical connection 36 on the left hand-side of FIG. 2 as well as the sections of the wires 14, 16 located to the right of the electrical connection 36 on the right hand-side of FIG. 2. To ensure a break-in detection as comprehensive as possible thus it is of advantage to fix the electrical connections 36 between the wires 14, 16 at the outer ends of the interlaced fabric 12. During the installation the interlaced fabric 12 can be folded over on the periphery so that the monitoring as far as up to the periphery is provided.

FIG. 3 illustrates the electrical contacting of the wires 14, 16 of the security material 10 according to the invention from FIG. 2. Here, in the plane of the interlaced fabric 12 a section of the interlaced fabric 12 located in proximity to the electrical connection 36 depicted on the right hand-side in FIG. 2 can be seen with a printed circuit board 26 that is fixed on the interlaced fabric 12. The printed circuit board 26 is fixed on a side surface of the interlaced fabric 12 in such a manner that the printed circuit board 26 lies above one or two partial sections of the second wire 16. In this way the two electrical connections 36 shown on the right hand-side in FIG. 2 can be connected directly to the printed circuit board 26, for example through soldering. Starting from these electrical connections 36, cables 42 are guided to the measurement electronics 20. Alternatively, all wires and electrical connections can be arranged on one side surface of the interlaced fabric 12.

FIG. 4 and FIG. 5 describe two embodiments of a security material 10 according to the invention, in which openings 22, 24 are located in the interlaced fabric 12. FIG. 4 shows a top view of such a security material 10, in which a hole was cut into the interlaced fabric 12 and the disconnected wire sections were replaced by corresponding conductor paths 38 of a printed circuit board 26. To this end a printed circuit board 26 which is larger than the opening 22 located in the interlaced fabric 12 is fixed onto the said opening 22. Through the opening 22 e.g. a bolt 32 can be inserted through the interlaced fabric 12. Around the opening 22 several wire ends 40 are located on top and below which developed when the opening 22 was made. Consequently, the conductor paths 38 of the printed circuit board 26 have to be positioned in such a way that they mutually connect the respective wire ends 40, which had previously been connected to each other by means of wire sections, through a respective electrical connection 36 whilst bypassing the opening 22.

FIG. 5 represents a further possibility of introducing an opening into the security material 10. For this purpose the interlaced fabric 12 is initially reinforced by a seam tape 34 at the place where the interlaced fabric 12 is to be cut open and is then cut open along two parallel wire sections of the second wire 16. If the two ends of the cut are moved against each other, a slot-shaped opening 24 is formed through which a bolt 32 can be inserted for example.

1. Security material having a web-like interlaced fabric and insulated, electrically conductive wires integrated therein,
wherein
a first wire is arranged in the longitudinal direction of the web-like interlaced fabric and
a second wire extends in a meandering manner across the width (B) of the web-like interlaced fabric in the longitudinal direction thereof.

2. Security material according to claim 1,
wherein
the first wire is arranged on a periphery of the interlaced fabric.

3. Security material according to claim 1,
wherein
on at least one side surface of the interlaced fabric the wires do not protrude from the said side surface for protection against damage.

4. Security material according to claim 1,
wherein
the spacing (D) of two adjacent sections of the second wire to each other lies in the range of millimeters, in particular 2.3 mm.

5. Security material according to claim 1,
wherein
the wires are enamel-insulated metal wires, in particular copper wires, the diameters of which lie in the range of some 50 micrometers, in particular between 100 and 150 μm.

6. Security material according to claim 1,
wherein
each wire has a respective connecting element for electrically connecting the wires to a measurement electronics.

7. Security material according to claim 1,
wherein
the first wire and the second wire are electrically connected to each other at their adjacent ends and the two other ends of the wires are connected to the measurement electronics for measuring the conductivity of the connected wires.

8. Security material according to claim 6,
wherein
the electrical connection of the wires to the measurement electronics is effected through soldering, welding or by means of insulation displacement connectors.

9. Security material according to claims 6,
wherein
the electrical connection of the wires to the measurement electronics is effected by way of a printed circuit board fixed on the interlaced fabric.

10. Security material according to claim 9,
wherein
the printed circuit board is flexible.

11. Security material according to claim 1,
wherein
the meanders of the second wire protrude laterally in the form of wire loops from the web-like interlaced fabric.

12. Security material according to claim 1,
wherein
for protection of the wire loops the lateral interlaced fabric edges and the wire loops are embedded in a seam tape, in particular having a thickness of 250 μm.

13. Security material according to claim 1,
wherein
the interlaced fabric has an opening for passing through lines, feed-throughs, connecting and fixing elements or the like, without interrupting wire connections at the place of the opening,
whereby on the interlaced fabric a printed circuit board is fixed above the opening, which is larger than the opening and whose conductor paths connect the respective ends of each wire connection to each other.

14. Security material according to claim 1,
wherein
the interlaced fabric has a slot-shaped opening for passing through lines, connecting elements or the like, without interrupting wire connections at the place of the opening,
whereby the slot extends along the sections of the second wire and the interlaced fabric in the vicinity of the slot is reinforced by a seam tape.

15. Security material according to claim 1,
wherein
the interlaced fabric has at regular intervals in the longitudinal direction, in particular every 25 mm, a marker line in the form of a missing thread that extends along the width.
